(19) United States
(12) Patent Application Publication
(10) Pub. No.: US 2016/0078095 A1
(43) Pub. Date: Mar. 17, 2016

(54) LOCATION-BASED UPDATING OF PROFILE DATA

(71) Applicant: Avid Dating Life Inc., Toronto (CA)

(72) Inventors: Joe Man, Toronto (CA); Rizwan Jiwan, Toronto (CA); Anand Agrawal, Brampton (CA); Robby Jennings, Toronto (CA); Teng Wang, Toronto (CA); Stella Kapakos, Toronto (CA); Sergiy Tytarenko, Whitby (CA)

(21) Appl. No.: 14/486,386

(22) Filed: Sep. 15, 2014

(51) Int. Cl. G06F 17/30; H04W 4/02; G01B 21/00

(52) U.S. Cl. CPC G06F 17/30528; G01B 21/00; H04W 4/02; G06F 17/30241; G06F 17/30321; G06F 17/30371; G06F 17/30554

(57) ABSTRACT

A method of updating user profile data involves at least one processor receiving from a mobile device a user identifier and first current position data associated with a first current location of the mobile device. The processor(s) queries a search index with the identifier for a profile associated with the user identifier, determines from the first current position data that the mobile device is outside a default location defined in the profile, and incorporates into the search index profile data in association with first current location information derived from the first current position data. The processor(s) receive(s) from the mobile device the user identifier and second current position data associated with a second current location of the mobile device, determines from the second current position data that the device is within the default location, and removes from the search index the first current location information associated with the profile data.

### FIELD OF THE INVENTION

This patent application relates to a method and system for updating profile data.

### BACKGROUND

In order to enhance a web user's experience and/or provide more relevant information in response to web-based queries, a website might maintain a profile for each of its registered users. Each profile might include demographic information (e.g. date of birth, sex, income level), location information (e.g. city, state, country) and/or preference information (e.g. preferred language, billing address) for the respective web user, which the web site accesses when the web user accesses the web site.

Although most of the information saved in the profile can remain static (e.g. date of birth, sex, income level, preferred language, billing address), some information saved in the profile might need to be periodically updated. Kuhn (US 2012/0185419) describes dynamically building a user profile based on the user's current position relative to a point-of-interest, and supplying different information to the user based on the current state of the user's profile (e.g. whether the user is visiting the point-of-interest as a customer or as an employee). This approach to profile updating is computationally intensive since the user's profile must be accessed and dynamically updated in response to each location update transmitted by the user.

### SUMMARY

This patent application discloses a profile query processing system and associated methods that determine a user's current location relative to a previous location, prior to dynamically updating profile data.

In accordance with a first aspect of the disclosure, there is provided a method of processing profile queries that involves at least one processor updating a search index by (i) receiving from a mobile device a user identifier and first current position data associated with a first current location of the mobile device, (ii) querying the search index with the user identifier for a user profile associated with the user identifier, the user profile comprising profile data including at least default location information defining a default location, (iii) determining from the first current position data that the mobile device is outside the default location, and (iv) and incorporating into the search index the profile data in association with first current location information derived from the first current position data.

The at least one processor further updates the search index by (i) receiving from the mobile device the user identifier and second current position data associated with a second current location of the mobile device, (ii) determining from the second current position data that the mobile device is within the default location, and (iii) removing from the search index the first current location information associated with the profile data.

Subsequent to incorporating the first current location information into the user profile or the removing the first current location information from the user profile, the at least one processor (i) receives from a communications terminal a query comprising at least one query parameter, one of the at least one query parameters comprising location, (ii) locates the user profile by querying the location information in the search index with the one of the at the least one query parameters, and (iii) displaying on the communications terminal the profile data associated with the user profile.

In accordance with this first aspect of the disclosure, there is also provided a profile query processing system that includes a search index, and at least one processor in communication with the search index. The at least one processor is configured to update the search index by (i) receiving from a mobile device a user identifier and first current position data associated with a first current location of the mobile device, (ii) querying the search index with the user identifier for a user profile associated with the user identifier, the user profile comprising profile data including at least default location information defining a default location, (iii) determining from the first current position data that the mobile device is outside the default location, and (iv) incorporating into the search index the profile data in association with first current location information derived from the first current position data.

The at least one processor is configured to further update the search index by (i) receiving from the mobile device the user identifier and second current position data associated with a second current location of the mobile device, (ii) determining from the second current position data that the mobile device is within the default location, and (iii) removing from the search index the first current location information associated with the profile data.

The at least one processor is also configured to, subsequent to the incorporating the first current location information into the search index and the removing the first current location information from the search index (i) receive from a communications terminal a query comprising at least one query parameter, one of the at least one query parameters comprising location, (ii) locate the user profile by querying the location information in the search index with the one of the at the least one query parameters, and (iii) display on the communications terminal the profile data associated with the user profile.

The at least one processor may be configured to further update the search index by, prior to the receiving the second current position data, (i) receiving from the mobile device third current position data associated with a third current location of the mobile device, (ii) determining from the third current position data that the mobile device is outside the first current location, (iii) removing from the search index the first current location information associated with the profile data, and (iv) incorporating into the search index the profile data in association with third current location information derived from the third current position data.

The at least one processor may also be configured to further update the search index by, prior to receiving the second current position data, determining that a maximum time period has elapsed since the incorporating the first current location information into the search index, and removing from the search index the first current location information associated with the profile data.

In accordance with a second aspect of the disclosure, there is provided a method of updating profile data that involves at least one processor (i) receiving from a mobile device a user identifier and first current position data associated with a first current location of the mobile device, (ii) querying a search index with the user identifier for a user profile associated with the user identifier, the user profile comprising profile data including at least default location information defining a default location, (iii) determining from the first current position data that the mobile device is outside the default location, and (iv) incorporating into the search index the profile data in association with first current location information derived from the first current position data.

The at least one processor further updates the user profile data by (i) receiving from the mobile device the user identifier and second current position data associated with a second current location of the mobile device, (ii) determining from the second current position data that the mobile device is within the default location, and (iii) removing the first current location information from the user profile, and (iv) excluding the second current location information from the user profile.

In accordance with this second aspect of the disclosure, there is also provided a user profile updating system that includes a database, and at least one processor in communication with the database. The database includes a search index, and the at least one processor is configured to (i) receive from a mobile device a user identifier and first current position data associated with a first current location of the mobile device, (ii) query the search index with the user identifier for a user profile associated with the user identifier, the user profile including default location information defining a default location, (iii) determine from the first current position data that the mobile device is outside the default location, and (iv) incorporate into the user profile first current location information derived from the first current position data.

The at least one processor is also configured to (i) receive from the mobile device the user identifier and second current position data associated with a second current location of the mobile device, (ii) determine from the second current position data that the mobile device is within the default location, (iii) removing from the search index the first current location information associated with the profile data.

The at least one processor may also be configured to, prior to receiving the second current position data, (i) receive from the mobile device third current position data associated with a third current location of the mobile device, (ii) determine from the third current position data that the mobile device is outside the first current location, (iii) remove from the search index the first current location information associated with the profile data, and (iv) incorporate into the search index the profile data in association with third current location information derived from the third current position data.

The at least one processor may also be configured to, prior to receiving the second current position data, (i) determine that a maximum time period has elapsed since incorporating the first current location information into the search index, and (ii) remove from the search index the first current location information associated with the profile data.

### BRIEF DESCRIPTION OF THE DRAWINGS

An exemplary profile query processing system, method of updating user profile data and method of processing profile queries will now be described, with reference to the accompanying drawings, in which:

FIG. 1 is a schematic view of a user profile processing network, depicting a communications terminal, a mobile communications device, a user profile updating system, and a profile query processing system;

FIG. 2 is a schematic view of one of the mobile communications devices;

FIG. 3 is a schematic view of the user profile updating system;

FIG. 4 is a schematic view of the profile query processing system; and

FIG. 5 is a message flow diagram depicting one embodiment of the methods; and

FIG. 6 is a message flow diagram depicting an alternate embodiment of the methods.

### DETAILED DESCRIPTION

### User Profile Processing Network

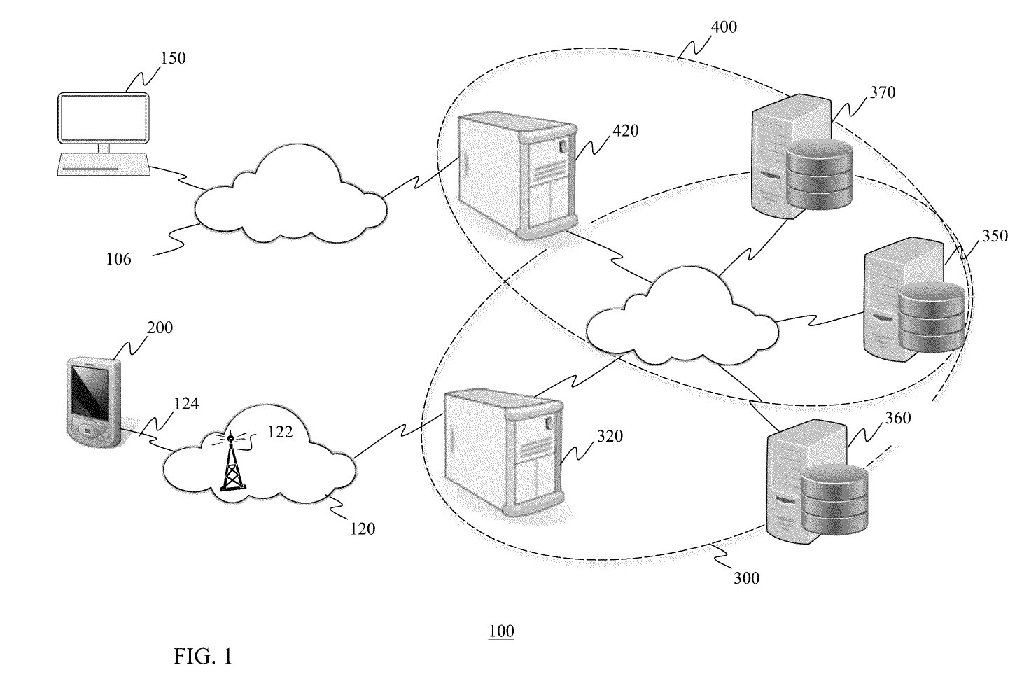

FIG. 1 is a schematic view of a user profile processing network, denoted generally as 100. As shown, the user profile processing network 100 comprises a communications terminal 150, a mobile communications device 200, a user profile updating system 300, and a profile query processing system 400. Although the user profile processing network 100 is shown comprising only a single communications terminal 150 and a single mobile communications device 200, typically the user profile processing network 100 includes a plurality of the communications terminals 150 and a plurality of the mobile communications devices 200.

The communications terminal 150 is configured to communicate with the profile query processing system 400 via a communications network 106. As non-limiting examples, one or more of the communications terminals 150 could be implemented as a personal computer, a tablet computer, a smart phone, or an internet-enabled personal data assistant (PDA).

The mobile communications device 200 is configured to communicate with the user profile updating system 300 via a mobile communications network 120. As non-limiting examples, one or more of the mobile communications device 200 could be implemented as a wireless-enabled tablet computer, a wireless-enabled PDA, or a smart phone.

The mobile communications network 120 may include a WiFi network, a cellular network, or a combination thereof. Therefore, as shown, the mobile communications network 120 comprises a plurality of wireless base station subsystems 122. The mobile communications devices 200 communicate with the base station subsystems 122 via wireless links 124, and the base station subsystems 122 communicate with the user profile updating system 300 via a wired, wireless or optical link. Accordingly, the base station subsystems 122 act as a bridge between the mobile communications devices 200 and the user profile updating system 300.

The user profile updating system 300 is configured to communicate with the mobile communications devices 200 via the mobile communications network 120. The profile query processing system 400 configured to communicate with the communications terminals 150 via the communications network 106.

### Mobile Device

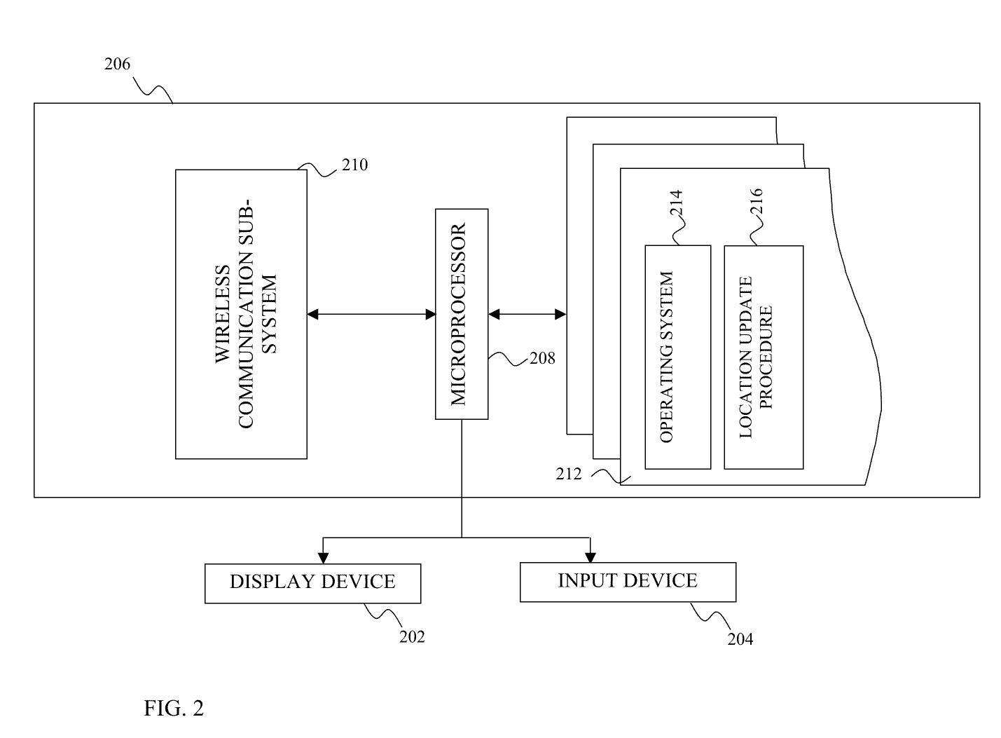

A sample mobile communications device 200 is depicted in FIG. 2. As shown, the mobile communications device 200 includes a display 202, user input device 204, and a computer processing system 206. The user input device 204 may be provided as a keyboard, biometric input device (e.g. microphone) and/or a touch-sensitive layer provided on the display 202. The computer processing system 206 comprises a microprocessor 208, a wireless communication sub-system 210 and a computer-readable medium 212.

The communication sub-system 210 allows the mobile device 200 to communicate with the mobile communications network 120. As discussed, the mobile communications network 120 may be configured as a WiFi network, a cellular network, or a combination thereof. Accordingly, the communication sub-system 210 allows the mobile device 200 to transmit and receive wireless communications signals over WiFi networks and/or cellular networks.

The computer-readable medium 212 typically comprises non-volatile non-transient electronic computer memory that stores computer processing instructions which, when accessed from the memory 212 and executed by the microprocessor 208, implement an operating system 214 and a location update procedure 216. The operating system 214 is configured to display output on the display 202, to receive user input from the input device 204, and to send and receive communication signals over the wireless link 124 of the mobile communications network 120.

The operation of the location update procedure 216 will be discussed in greater detail below. However, it is sufficient at this point to note that the location update procedure 216 is configured to periodically transmit to the user profile updating system 300, via the mobile communications network 120, a location update message that includes a user identifier that is uniquely associated with the user of the mobile communications device 200, and position data that is associated with the current location of the mobile communications device 200.

Preferably, the position data comprises longitude/latitude co-ordinate data that identifies the current position of the mobile communications device 200, and the location update procedure 216 determines the current position of the mobile communications device 200, for example, from the WiFi network and/or cellular network of the mobile communications network 120 and/or from a GPS receiver installed in the mobile communications device 200.

### User Profile Updating System

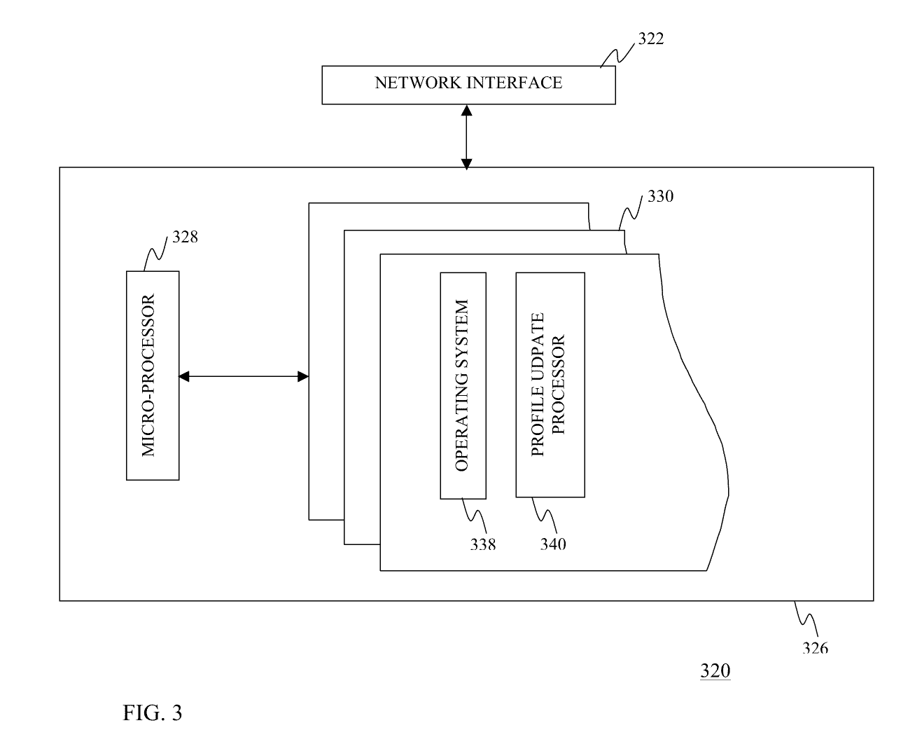

As shown in FIG. 1, the user profile updating system 300 includes a profile updating server 320, a user profile database 350, a current location database 360, and a search index 370. A sample profile updating server 320 is depicted in FIG. 3. As shown, the profile updating server 320 includes a network interface 322, and a computer processing system 326 that is coupled to the network interface 322. The network interface 322 interfaces the profile updating server 320 with the mobile communications network 120 to thereby allow the profile updating server 320 to communicate with the mobile communications devices 200. The network interface 322 also allows the profile updating server 320 to access the user profile database 350, the current location database 360 and the search index 370.

As will be discussed in greater detail below, the user profile database 350 includes a plurality of user profiles, each associated with a respective registered user of the user profile updating system 300. Each user profile comprises profile data that includes at least default location information defining a default location for the registered user. The current location database 360 saves current location data associated with the current position of each user's mobile communications device 200. The search index 370 is compiled from all the user profiles saved in the user profile database 350 and from the location data saved in the current location database 360, and is used by the profile query processing system 400 to respond to database queries received from the communications terminal 150.

The computer processing system 326 may include one or more microprocessors 328 and a computer-readable medium 330. The computer-readable medium 330 typically comprises non-volatile non-transient memory and may be provided as electronic computer memory (e.g. flash memory) or optical or magnetic memory (e.g. compact disc, hard disk). The memory 330 maintains computer processing instructions stored thereon which, when executed by the microprocessor(s) 328, define an operating system 338 and a profile update processor 340. The operating system 338 controls the overall operation of the profile updating server 320.

The operation of the profile update processor 340 will be discussed in greater detail below. However, it is sufficient at this point to note that the profile update processor 340 is configured to update the search index 370 by (i) receiving from one of the mobile communications devices 200 a user identifier (uniquely associated with one of the registered users of the user profile updating system 300) and first current position data (associated with a first current location of the mobile communications device 200), (ii) querying the search index 370 with the user identifier for the user profile that is associated with the user identifier, (iii) determining from the first current position data that the mobile communications device 200 is outside the default location specified in the user profile, and (iv) incorporating into the search index 370 the profile data in association with first current location information derived from the first current position data.

The profile update processor 340 is also configured to update the search index by (i) receiving from the mobile communications devices 200 the user identifier and second current position data (associated with a second current location of the mobile communications device 200), (ii) determining from the second current position data that the mobile communications device 200 is within the default location specified in the user profile, and (iii) removing from the search index 370 the first current location information associated with the profile data.

Although the profile update processor 340 is typically implemented as computer processing instructions, all or a portion of the functionality of the profile update processor 340 may be implemented instead in electronics hardware, such as a field programmable logic gate array (FPGA) or a complex programmable logic device (CPLD).

### Profile Query Processing System

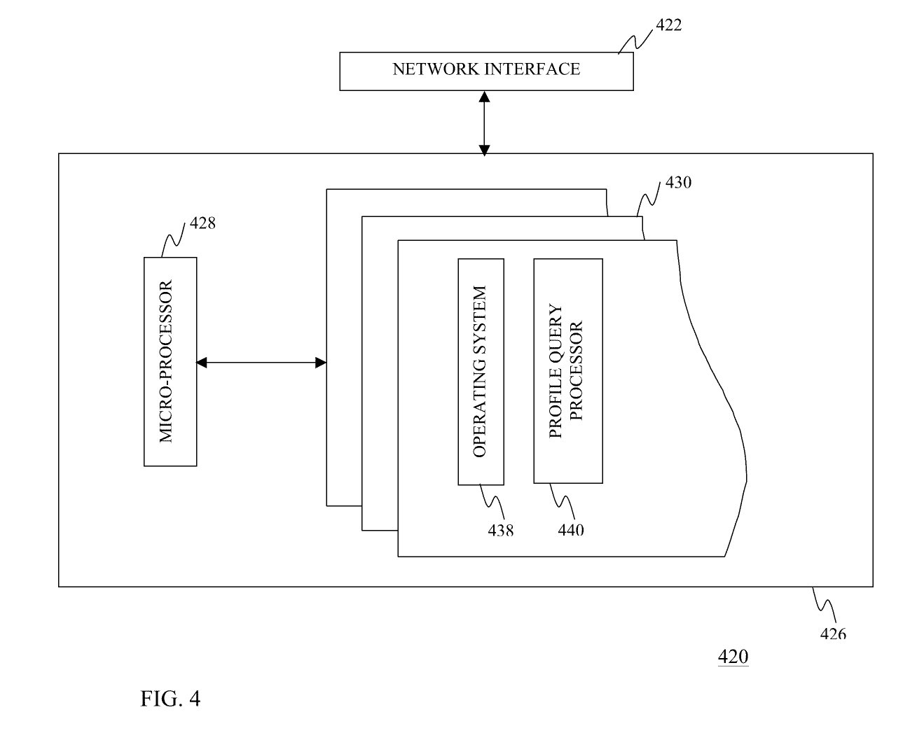

As shown in FIG. 1, the profile query processing system 400 includes a profile query processing server 420, the user profile database 350 and the search index 370. A sample profile query processing server 420 is depicted in FIG. 4. As shown, the profile query processing server 420 includes a network interface 422, and a computer processing system 426 that is coupled to the network interface 422. The network interface 422 interfaces the profile query processing server 420 with the communications network 106 to thereby allow the profile query processing server 420 to communicate with the communications terminals 150. The network interface 422 also allows the profile query processing server 420 to access the user profile database 350 and the search index 370.

The computer processing system 426 may include one or more microprocessors 428 and a computer-readable medium 430. The computer-readable medium 430 typically comprises non-volatile non-transient memory and may be provided as electronic computer memory (e.g. flash memory) or optical or magnetic memory (e.g. compact disc, hard disk). The memory 430 maintains computer processing instructions stored thereon which, when executed by the microprocessor(s) 428, define an operating system 438 and a profile query processor 440. The operating system 438 controls the overall operation of the profile updating server 420.

The operation of the profile query processor 440 will be discussed in greater detail below. However, it is sufficient at this point to note that the profile query processor 440 is configured to (i) receive from one of the communications terminals 150 a query comprising at least one query parameter, one of the parameters comprising location, (ii) locate a user profile by querying the location information in the search index with the query parameter(s), and (iii) display on the communications terminal 150 the profile data associated with the user profile.

The profile query processor 440 might receive the query from the communications terminal 150 after the profile update processor 340 incorporates the current location information into the search index or removes the current location information from the search index. In this situation, the query performed by the profile query processor 440 will locate all user profiles that have current location information or default location information that correspond with the location specified in the query parameter.

Alternately, the profile query processor 440 might query the search index with the communications terminal 150 before the profile update processor 340 incorporates current location information into the search index or after the profile update processor 340 removes current location information from the search index. In this latter situation, the query performed by the profile query processor 440 will only locate such a user profile if it has default location information that corresponds with the location specified in the query parameter.

Although the profile query processor 440 is typically implemented as computer processing instructions, all or a portion of the functionality of the profile query processor 440 may be implemented instead in electronics hardware, such as a field programmable logic gate array (FPGA) or a complex programmable logic device (CPLD).

### User Profile Database

As discussed above, the user profile database 350 includes a plurality of user profiles, each associated with a respective registered user of the user profile updating system 300. Each user profile includes profile data that is associated with the registered user. As non-limiting examples, the profile data may include user identity information (e.g. userID, user's legal name), user demographic information (e.g. date of birth, sex, income level), and/or user preference information (e.g. language, interests, extra-curricular activities) for the registered user.

Each user profile also includes default location information that defines a default location for the associated registered user (e.g. longitude/latitude co-ordinate data, and the corresponding geographic location (e.g. at least one of street, city, municipality, county, state, and country) in which the registered user normally works or resides).

### Current Location Database

The current location database 360 stores current location information that is associated with the current location (e.g. longitude/latitude co-ordinate data, and the corresponding geographic location (e.g. at least one of street, city, municipality, county, state, and country)) of each user's mobile communications device 200.

### Search Index

The profile update processor 340 compiles the search index 370 from one or more of the classes of the profile data that is saved in the user profiles of the user profile database 350. Continuing the foregoing non-limiting examples, the search index 370 may be compiled from the identity information, demographic information and preference information saved in the user profiles. The search index 370 is also compiled from the default location information saved in the user profiles.

The search index 370 is also compiled from the current location information that is saved in the current location database 360. Therefore, in addition to the default location of each registered user, the search index 370 may include (in association with each user's profile data) current location information that is associated with the current location of each user's mobile communications device 200.

### Method of Updating User Profile Data/Processing Profile Queries

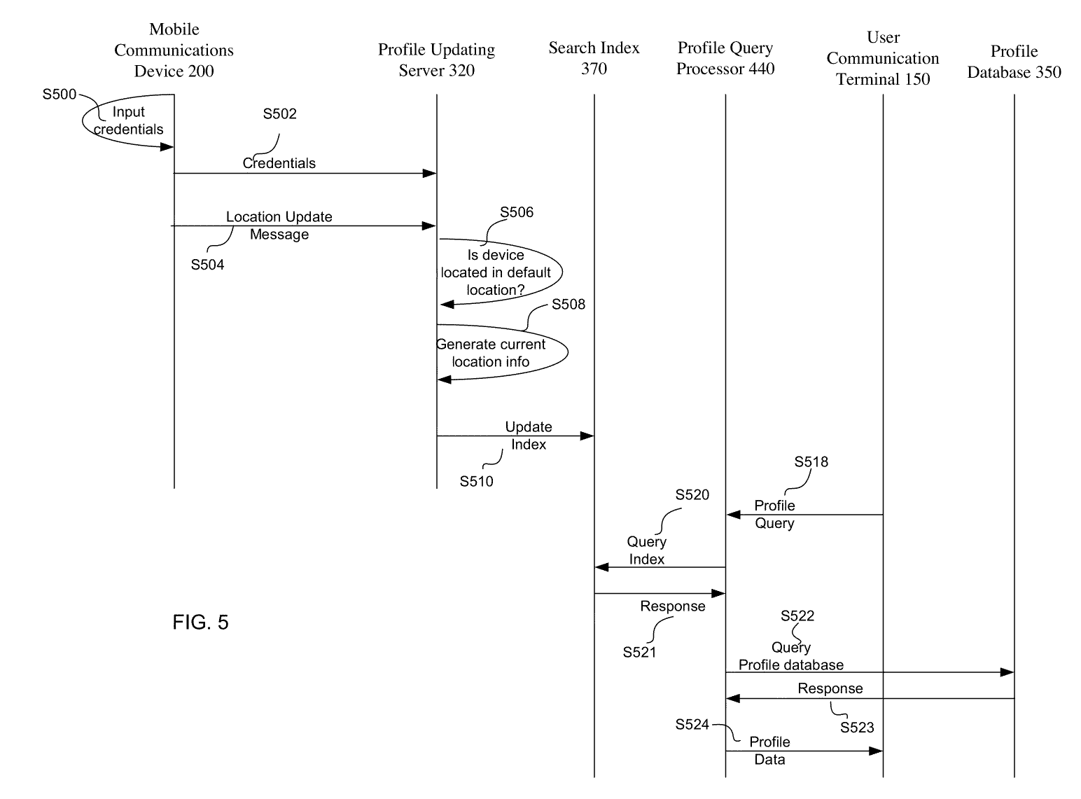

As discussed, the user profile processing network 100 implements a method of updating user profile data and a method of processing profile queries. A sample embodiment of the methods will be discussed with reference to FIG. 5. In this embodiment, each user profile saved in the user profile database 350 comprises profile data that includes at least default location information for the associated registered user. The search index 370 is compiled from at least the default location information of all the user profiles saved in the user profile database 350.

The profile update processor 340 updates the search index 370 by (i) receiving from one of the mobile communications devices 200 a user identifier and first current position data associated with a first current location of the mobile communications device 200, (ii) querying the search index 370 with the user identifier for a user profile associated with the user identifier, (iii) determining from the first current position data that the mobile communications device 200 is outside the default location specified in the located user profile, and (iv) incorporating into the search index the profile data in association with first current location information derived from the first current position data.

The profile update processor 340 may further update the search index 370 by (i) receiving from the mobile communications device 200 the user identifier and second current position data associated with a second current location of the mobile communications device 200, (ii) determining from the second current position data that the mobile communications device 200 is within the default location, and (iii) removing from the search index 370 the first current location information associated with the profile data.

Subsequent to incorporating the first current location information into the search index 370 or the removing the first current location information from the search index 370, the profile query processor 440 (i) receives from one of the communications terminals 150 a query comprising at least one query parameter (that includes location), (ii) locates a user profile by querying the location information in the search index 370 with the query parameter(s), and (iii) displaying on the communications terminal 150 the profile data associated with the located user profile.

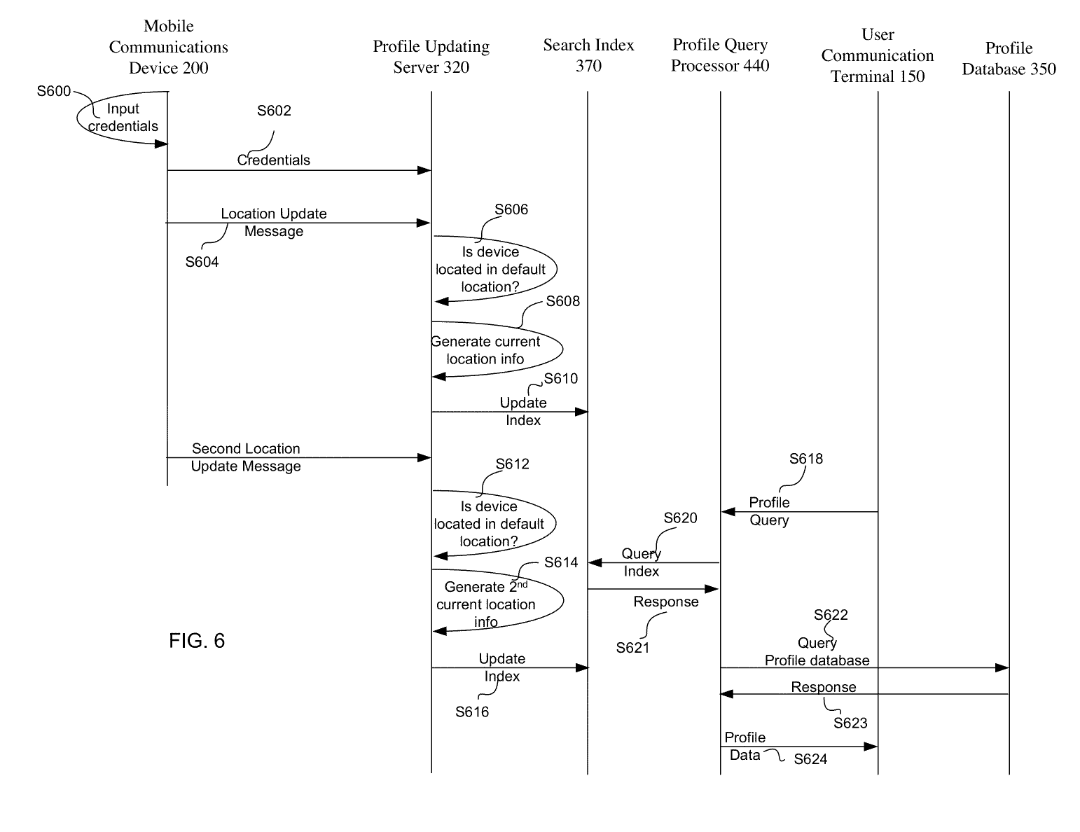

Two example embodiments of the user profile data updating method and the profile query processing method will now be discussed in detail with reference to FIGS. 5 and 6. In both embodiments, each user profile saved in the user profile database 350 includes identity information (e.g. userID), demographic information, preference information, and default location information for the associated registered user.

Typically, each registered user of the user profile processing network 100 provides the user profile processing network 100 with profile data, which the user profile processing network 100 saves in the user's profile when the user first registers with the user profile processing network 100. As non-limiting examples, the user may provide the profile data for his/her user profile information via a communications terminal 150, a telephone, or mail.

When the user first registers with the user profile processing network 100, the user may also provide the user profile processing network 100 with identity credentials (e.g. userID, passcode) that the user desires to use to authenticate to the user profile processing network 100. Alternately, the user profile processing network 100 may provide the user with the identity credentials after completing the registration process. The user profile processing network 100 may save the user's identity credentials in the user profile database 350, preferably in encrypted form.

After receiving the profile data from the user, the user profile processing network 100 recompiles the search index 370 using a portion of the profile data of all the user profiles that are saved in the user profile database 350. Preferably, the search index 370 is compiled from the identity information, demographic information, preference information and the default location information.

Turning now to FIG. 5, after the user registers with the user profile processing network 100 and the search index 370 has been compiled, the registered user uses initiates the user profile data updating method by invoking the location update procedure 216 on one of the mobile communications devices 200. In response, the mobile communications device 200 initiates a communication session with the profile updating server 320 via the mobile communications network 120, and the location update procedure 216 prompts the user to input his/her identity credentials (userID, passcode).

The user inputs his/her identity credentials via the user input device 204 at step S500, and the location update procedure 216 attempts to authenticate the user to the profile updating server 320 by providing the profile updating server 320 with the identity credentials, at step S502. The profile updating server 320 authenticates the user by validating the provided identity credentials against the credentials that are saved in the user profile database 350.

After the device user successfully authenticates to the profile updating server 320, the profile updating server 320 may establish an encrypted communications channel with the mobile communications device 200 via the mobile communications network 120. Thereafter, at step S504, using the encrypted communications channel (if established) the location update procedure 216 transmits to the profile updating server 320, via the mobile communications network 120, a location update message that includes (i) the registered user's userID, and (ii) current position data that is associated with the current location of the mobile communications device 200.

As discussed above, preferably the current position data transmitted to the profile updating server 320 comprises longitude/latitude co-ordinate data that identifies the current position of the mobile communications device 200. Further, preferably the location update procedure 216 thereafter periodically (e.g. every 10 minutes) transmits location update messages to the profile updating server 320 via the mobile communications network 120, or until the user terminates the location update procedure 216.

Upon receipt of a location update message from one of the mobile communications devices 200, the profile update processor 340 of the profile updating server 320 queries the search index 370 with the received userID (included in the location update message) to locate the user profile (if any) that is associated with the received userID. If the profile update processor 340 does not locate a user profile that is associated with the received userID, the profile update processor 340 ignores the location update message. However, if the profile update processor 340 locates a user profile that is associated with the received userID, at step S506 the profile update processor 340 determines whether the mobile communications device 200 is currently located within the default location specified in the located user profile.

In one implementation, the profile update processor 340 determines whether the mobile communications device 200 is currently located within the default location by determining whether the current position is within a predetermined distance from the default location. To do so, the profile update processor 340 compares the longitude/latitude co-ordinate data of the current position (included in the location update message) with the longitude/latitude co-ordinate data of the default location specified in the search index 370 to thereby determine the current distance of the mobile communications device 200 from the default location. The profile update processor 340 then compares the current distance with the predetermined distance.

In another implementation, the profile update processor 340 determines whether the mobile communications device 200 is currently located within the default location by converting the longitude/latitude co-ordinate data of the current position to a current geographic location (e.g. city, municipality, county, state, and/or country), and determining whether the current geographic location corresponds to the default geographic location specified in the search index 370. The profile update processor 340 may convert the longitude/latitude co-ordinate data of the current position to a current geographic location using an online conversion services, such as Google Geo Lookup.

In either case, by determining from the search index 370 whether the mobile communications device 200 is currently located within the default location specified in the user's profile, the profile update processor 340 indirectly determines whether the registered user is currently located within the user's default location. If the profile update processor 340 determines from the current position data and the search index 370 that the mobile communications device 200 (registered user) is currently located within the default location specified in the user's profile, the profile update processor 340 again ignores the location update message.

However, if the profile update processor 340 determines from the current position data and the search index 370 that the mobile communications device 200 (registered user) is currently located outside the default location specified in the user's profile, at step S508 the profile update processor 340 generates current location information from the current position data, and saves the current location information in the current location database 360. Preferably, the current location information includes the current geographic location as derived from the longitude/latitude co-ordinate data of the current position, and may also include the corresponding longitude/latitude co-ordinate data of the current position. Further, preferably the profile update processor 340 saves the current location information in the current location database 360, in substantially real time after receipt of the location update message, together with a time stamp that identifies the date/time at which the current location information was saved in the current location database 360.

At step S510, the profile update processor 340 updates the search index 370 by incorporating the current location information into the search index 370, in association with the profile data of the user's profile. Preferably, the profile update processor 340 associates the current location information with the profile data of the user's profile by recompiling the search index 370 from the identity information, demographic information, preference information, and default location information of all the user profiles saved in the user profile database 350, and from all the current location information saved in the current location database 360.

Preferably, the profile update processor 340 periodically recompiles the search index 370 from the user profile database 350 and the current location database 360. Further, prior to recompiling the search index 370, preferably the profile update processor 340 determines whether any item of current location information saved in the current location database 360 has expired. To do so, the profile update processor 340 determines whether the time stamp (if any) associated with any item of current location information saved in the current location database 360 pre-dates the current date/time by a predetermined maximum time (e.g. more than 12 hours).

If the profile update processor 340 determines that any item of current location information currently saved in the current location database 360 has expired, the profile update processor 340 removes the expired item of current location information from the current location database 360, prior to recompiling the search index 370. As will be appreciated, by recompiling the search index 370 after the profile update processor 340 removes the expired item of current location information from the current location database 360 causes the expired item of current location information to be removed from the search index 370.

At step S518, the profile query processor 440 may receive from one of the communications terminals 150 a profile query for one or more registered users of the user profile processing network 100. The profile query includes one or more query parameters. As non-limiting examples, one or more of the query parameters may be demographic information (e.g. sex, income level), and user preference information (e.g. language, interests, extra-curricular activities) of the registered user(s). Preferably, one of the query parameters is the location (current or default) of the registered user(s). Although the location information in the search index 260 may include longitude/latitude co-ordinate data, typically the location is specified in the query as a geographic location (e.g. at least one of street, city, municipality, county, state, and country) of the registered user(s).

After receiving the profile query at step S518, the profile query processor 440 locates user profiles that match one or more of the query parameters specified in the profile query, at step S520, by querying the search index 370 with the specified query parameters. At step S521, the profile query processor 440 receives a response from the search index 370 with the results of the profile query. At step S522, the profile query processor 440 queries the profile database 350 with the identity information (e.g. userID) of the located user profiles for the profile data from each of the respective located user profiles. At step S523, the profile query processor 440 receives a response from the profile database 350 with profile data from each of the respective located user profiles. The profile query processor 440 then responds to the profile query, at step S524, by transmitting the profile data to the communications terminal 150. The communications terminal 150 then displays the profile data on the display device thereof

Since the location update procedure 216 may periodically transmit location update messages to the profile updating server 320, the profile updating server 320 may receive one or more additional location update messages from the mobile communications device 200 before the profile query processor 440 receives a profile query from one of the communications terminals 150. This latter scenario is depicted in FIG. 6.

Reference numbers S600 to S610, S618 to S624 of FIG. 6 correspond to reference numbers S500 to S510, S518 to S524 of FIG. 5. Therefore, after the user registers with the user profile processing network 100, the search index 370 has been compiled, and the registered user authenticates to the profile updating server 320, at step S604 the location update procedure 216 of the user's mobile communications device 200 transmits to the profile updating server 320, via the mobile communications network 120, a location update message that includes (i) the registered user's userID, and (ii) current position data that is associated with the current location of the mobile communications device 200.

Upon receipt of the location update message, the profile update processor 340 of the profile updating server 320 queries the search index 370 with the received userID to locate the user profile (if any) that is associated with the received userID. If the profile update processor 340 locates a user profile that is associated with the received userID, at step S606 the profile update processor 340 determines whether the mobile communications device 200 is currently located within the default location specified in the located user profile.

If the profile update processor 340 determines from the current position data and the search index 370 that the mobile communications device 200 (registered user) is currently located outside the default location specified in the user's profile, at step S608 the profile update processor 340 generates current location information from the current position data, and saves the current location information in the current location database 360 in substantially real time after receipt of the location update message. At step S610, the profile update processor 340 updates the search index 370 by incorporating the current location information into the search index 370, in association with the profile data of the user's profile.

As discussed above, preferably the profile update processor 340 associates the current location information with the profile data of the user's profile by recompiling the search index 370 from the identity information, demographic information, preference information, and default location information of all the user profiles saved in the user profile database 350, and from all the current location information saved in the current location database 360.

Again, preferably the profile update processor 340 periodically recompiles the search index 370 from the user profile database 350 and the current location database 360. Further, preferably the profile update processor 340 removes from the current location database 360 any expired item of current location information, prior to recompiling the search index 370, to thereby remove the expired item of current location information from the search index 370.

Preferably, the user location update procedure 216 of the user's mobile communications device 200 periodically transmits location update messages to the profile updating server 320 via the mobile communications network 120. Upon receipt of a second (or subsequent) location update message from the user's mobile communications device 200, the profile update processor 340 again queries the search index 370 with the received userID (included in the location update message) to locate the user profile that is associated with the received userID. If the profile update processor 340 locates a user profile that is associated with the received userID, at step S612 the profile update processor 340 determines whether the mobile communications device 200 is currently located within the default location specified in the located user profile.

As discussed above, the profile update processor 340 may determine whether the mobile communications device 200 is currently located within the default location by determining whether the second (subsequent) current position is within a predetermined distance from the default location, or by converting the longitude/latitude co-ordinate data of the second (subsequent) current position to a second (subsequent) current geographic location (e.g. city, municipality, county, state, and/or country), and determining whether the second (subsequent) current geographic location corresponds to the default geographic location specified in the search index 370.

If the profile update processor 340 determines from the second (subsequent) current position data and the search index 370 that the mobile communications device 200 (registered user) is still located outside the default location specified in the user's profile, at step S614 the profile update processor 340 generates second (subsequent) current location information from the second (subsequent) current position data, and saves the second (subsequent) current location information in the current location database 360.

After the profile update processor 340 saves the second (subsequent) current location information in the current location database 360, at step S616 the profile update processor 340 updates the search index 370 by removing from the search index 370 the previous current location information that was saved in the search index 370 in association with the profile data of the user's profile, and by incorporating the second (subsequent) current location information into the search index 370, in association with the profile data of the user's profile. Preferably, the profile update processor 340 removes the previous current location information and associates the second (subsequent) current location information with the profile data of the user's profile by recompiling the search index 370 from the identity information, demographic information, preference information, and default location information of all the user profiles saved in the user profile database 350, and from all the current location information saved in the current location database 360.

However, if, at step S612, the profile update processor 340 determines from the second (subsequent) current position data and the search index 370 that the mobile communications device 200 (registered user) is currently located within the default location specified in the user's profile, at step S614 the profile update processor 340 removes the previous current location information from the current location database 360. In this situation, the profile update processor 340 does not generate second (subsequent) current location information from the second (subsequent) current position data, or save the second (subsequent) current location information in the current location database 360.

After the profile update processor 340 removes the previous current location information from the current location database 360, at step S616 the profile update processor 340 updates the search index 370 by removing from the search index 370 the previous current location information that was saved in the search index 370 in association with the profile data of the user's profile. Preferably the profile update processor 340 removes from the search index 370 the previous current location information that was saved in the search index 370 in association with the profile data of the user's profile by recompiling the search index 370 from the identity information, demographic information, preference information, and default location information of all the user profiles saved in the user profile database 350, and from the all the current location information remaining in the current location database 360.

At step S618, the profile query processor 440 may receive from one of the communications terminals 150 a profile query for one or more registered users of the user profile processing network 100. The profile query includes one or more query parameters. Preferably, one of the query parameters is the location (current or default) of the registered user(s). Typically, the location is specified in the query as a geographic location (e.g. at least one of street, city, municipality, county, state, and country) of the registered user(s).

After receiving the profile query at step S618, the profile query processor 440 locates user profiles that match one or more of the query parameters specified in the profile query, at step S620, by querying the search index 370 with the specified query parameters. At step S621, the profile query processor 440 receives a response from the search index 370 with the results of the profile query. At step S622, the profile query processor 440 queries the profile database 350 with the identity information (e.g. userID) of the located user profiles for the profile data from each of the respective located user profiles. At step S523, the profile query processor 440 receives a response from the profile database 350 with profile data from each of the respective located user profiles. The profile query processor 440 then responds to the profile query, at step S624, by transmitting the profile data to the communications terminal 150. The communications terminal 150 then displays the profile data on the display device thereof.

1. A method of processing profile queries, the method comprising at least one processor:
updating a search index by receiving from a mobile device a user identifier and first current position data associated with a first current location of the mobile device, querying the search index with the user identifier for a user profile associated with the user identifier, the user profile comprising profile data including at least default location information defining a default location, determining from the first current position data that the mobile device is outside the default location, and incorporating into the search index the profile data in association with first current location information derived from the first current position data;
further updating the search index by receiving from the mobile device the user identifier and second current position data associated with a second current location of the mobile device, determining from the second current position data that the mobile device is within the default location, and removing from the search index the first current location information associated with the profile data; and
subsequent to one of the incorporating first current location information and the removing the first current location information:
receiving from a communications terminal a query comprising at least one query parameter, one of the at least one query parameters comprising location;
locating the user profile by querying the location information in the search index with the one of the at the least one query parameters; and
displaying on the communications terminal the profile data associated with the user profile.

2. The method according to claim 1, wherein the updating the search index further comprises, prior to the receiving second current position data, the at least one processor receiving from the mobile device third current position data associated with a third current location of the mobile device, determining from the third current position data that the mobile device is outside the first current location, removing the first current location information from the search index, and incorporating into the search index the profile data in association with third current location information derived from the third current position data.

3. The method according to claim 1, wherein the updating the search index further comprises, prior to the receiving second current position data, the at least one processor determining that a maximum time period has elapsed since the incorporating first current location information into the search index, and removing from the search index the first current location information associated with the profile data.

4. The method according to claim 1, wherein the receiving current position data comprises the at least one processor periodically receiving the current position data from the mobile device.

5. A profile query processing system comprising:
a search index;
at least one processor in communication with the search index and configured to:
update the search index by receiving from a mobile device a user identifier and first current position data associated with a first current location of the mobile device, querying the search index with the user identifier for a user profile associated with the user identifier, the user profile comprising profile data including at least default location information defining a default location, determining from the first current position data that the mobile device is outside the default location, and incorporating into the search index the profile data in association with first current location information derived from the first current position data;
further update the search index by receiving from the mobile device the user identifier and second current position data associated with a second current location of the mobile device, determining from the second current position data that the mobile device is within the default location, removing from the search index the first current location information associated with the profile data; and
subsequent to one of the incorporating first current location information and the removing the first current location information:
receive from a communications terminal a query comprising at least one query parameter, one of the at least one query parameters comprising location;
locate the user profile by querying the location information in the search index with the one of the at the least one query parameters; and
display on the communications terminal user profile data associated with the user profile.

6. The profile query processing system according to claim 5, wherein the at least one processor is further configured to update the search index by, prior to receiving the second current position data, receiving from the mobile device third current position data associated with a third current location of the mobile device, determining from the third current position data that the mobile device is outside the first current location, removing from the search index the first current location information associated with the profile data, and incorporating into the search index the profile data in association with third current location information derived from the third current position data.

7. The profile query processing system according to claim 5, wherein the at least one processor is further configured to update the search index by, prior to receiving the second current position data, determining that a maximum time period has elapsed since the incorporating first current location information into the search index, and removing from the search index the first current location information associated with the profile data.

8. The profile query processing system according to claim 5, wherein the at least one processor is configured to periodically receive the current position data from the mobile device.

9. A non-transient computer-readable medium carrying computer processing instructions stored thereon which, when executed by a computer, cause the computer to perform the method of claim 1.

10. A method of updating user profile data, the method comprising a processor:
receiving from a mobile device a user identifier and first current position data associated with a first current location of the mobile device;
querying a search index with the user identifier for a user profile associated with the user identifier, the user profile comprising profile data including at least default location information defining a default location;
determining from the first current position data that the mobile device is outside the default location, and incorporating into the user profile incorporating into the search index the profile data in association with first current location information derived from the first current position data;
receiving from the mobile device the user identifier and second current position data associated with a second current location of the mobile device; and
determining from the second current position data that the mobile device is within the default location, and removing from the search index the first current location information associated with the profile data.

11. The method according to claim 10, further comprising, prior to the receiving second current position data, the processor receiving from the mobile device third current position data associated with a third current location of the mobile device, determining from the third current position data that the mobile device is outside the first current location, removing from the search index the first current location information associated with the profile data, and incorporating into the search index the profile data in association with third current location information derived from the third current position data.

12. The method according to claim 10, further comprising, prior to the receiving second current position data, the processor determining that a maximum time period has elapsed since the incorporating first current location information into the search index, and removing from the search index the first current location information associated with the profile data.

13. The method according to claim 10, wherein the receiving current position data comprises the processor periodically receiving the current position data from the mobile device.

14. A non-transient computer-readable medium carrying computer processing instructions stored thereon which, when executed by a computer, cause the computer to perform the method of claim 10.
